(19) United States
(12) Patent Application Publication
(10) Pub. No.: US 2013/0252091 A1
(43) Pub. Date: Sep. 26, 2013

(54) Lithium Ion Battery Electrode and Its Fabrication Method

(71) Applicant: LONG POWER SYSTEMS (SUZHOU) CO., LTD., SUZHOU (CN)

(72) Inventor: BIYING HUANG, SUZHOU (CN)

(73) Assignee: LONG POWER SYSTEMS (SUZHOU) CO., LTD., SUZHOU (CN)

(21) Appl. No.: 13/850,346

(22) Filed: Mar. 26, 2013

(30) Foreign Application Priority Data
Mar. 26, 2012 (CN) 201210082241.6

(51) Int. Cl. H01M 4/131; H01M 4/04

(52) U.S. Cl. CPC H01M 4/131; H01M 4/0404
USPC 429/211; 427/58; 427/126.3; 427/126.6

(57) ABSTRACT

The present invention is aimed to provide a complex electrode for a lithium ion battery, consisting of: an electro-conductive current collector with porous three-dimensional network construction, the electrode active materials filled in the porous current collector, and a porous ionic conductive polymer binder coated in the pores of the current collector holding the electrode materials. In the abovementioned lithium ion battery complex electrode construction, the current collector connects with the electrode active materials through its highly porous three-dimensional backbone network and thus greatly improves the utilization of the electrode active materials and obtains high area density and low impedance of the electrode. Another objective of this invention is to disclose a novel electrode fabrication technique for lithium ion batteries.

### TECHNICAL FIELD

The present invention relates to a lithium ion battery field. More particularly, it relates to a novel electrode fabrication technique for a lithium ion battery.

### BACKGROUND OF THE INVENTION

Conventional electrode fabrication method for lithium ion battery is implemented by coating the electrode materials slurry with a certain binder onto a solid metal foil. This sort of electrode making method has a few disadvantages of the following: (1) less loading of electrode active materials due to more binder used and more current collector space occupied yields to a lower area density of electrode active materials; (2) relatively weak binding between the electrode materials and the smooth surface of current collector causes poor mechanical properties and limited anti-deformation capability of the electrode materials during the fabrication process and furthermore the electrode materials are prone to lose from the current collector. Accordingly, the lithium ion batteries made by such a traditional process usually have less satisfactory electrochemical performances such as low capacity, high impedance, and short cycle life. Furthermore, it also delivers high production cost and low production yield.

Generally solid metal foils such as stainless steel, aluminum, copper are selected as the current collector materials for battery electrodes. During cycling, with the electrode active materials undergoing lithium ion intercalation and deintercalation, their volume experiences expansion and contraction, for example, SiO₂ has volume change as high as 400% during cycling, and the mechanical stress generated due to the volume change accumulates with the prolonged cycling. Consequently, the accumulated stress could peel the electrode materials off from the current collector and the active materials lose close contact with each other and with the current collector. Accordingly, the cell impedance grows with the cycling and poor cycling performance is obtained. To avoid such a technical problem, the traditional electrode fabrication method allows relatively thin electrode and thus a low area density.

In the subsequent battery fabrication steps of the traditional method, in order to obtain the targeted capacity and energy density, thick coatings and a large amount of multilayer electrode stacks are demanded. However, thick coating brings to poor processability of the electrodes; multilayer stacks create high cell impedance and poor cycling performance. Furthermore, both of which lead to high production cost. On the other hand, the traditional battery fabrication includes multiple steps which are correlated with each other and this yields great difficulty for process and performance optimization such as cell impedance, cycle life, capacity and energy density and so on. Thick coating layers further bring to low mechanical properties of the electrode and the electrode materials are prone to peel off from the current collector or just crack. As a result, the electrode and the current collector are detached from each other or the electrode materials disconnect themselves. Therefore the construction and shape of the battery products by such a traditional method are restricted, particularly for the wounded cells.

### SUMMARY OF THE INVENTION

Based on the current existing technical problems abovementioned in the traditional battery electrode fabrication method, it is necessary to develop an innovative fabrication technique to improve the electrode active material utilization and the electrode processability.

A lithium ion battery electrode, consisting of:

a electro-conductive current collector, with a porous three-dimensional network construction;

an electrode active material, filled in the pores of the above mentioned current collector; and

a porous ionic conductive polymer binder layer, coated in the pores of the abovementioned current collector and the electrode active materials.

In a particular embodiment of the invention, the abovementioned electrode active material is a lithium ion compound selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄.

In another embodiment of the invention, the abovementioned electrode active material is selected from at least one of the following: C, Si, SiO₂, N containing compound, SnO₂, Sb₂O₃ and Li₄Ti₅O₁₂.

In another embodiment of the invention, the abovementioned current collector is porous metal foam with the porosity ranging from 20%-95%.

In another embodiment of the invention, the abovementioned electrode material is coated with the carbonized substance through the calcination process.

In another embodiment of the invention, the abovementioned porous ionic conductive polymer binder is selected from at least one of the following: PVDF, PTFE, PEO, PMA, or acrylate based gel polymer.

Still the present invention discloses an electrode fabrication method for a lithium ion battery, including:

mix the organic binder, conductive additive and the electrode active materials together with a certain solvent to form the electrode slurry;

load the electrode slurry into the pores and onto the both sides of the abovementioned porous electroconductive three-dimensional current collector using a doctor blade;

dry the abovementioned current collector loaded with the electrode slurry to remove the solvent;

dip coat a layer of ionic polymer binder solution on the current collector and the the electrode material and dry it to remove the solvent to form a complex electrode comprising the active electrode material, the current collector and the porous ionic conductive polymer binder.

In another particular embodiment of the invention, an additional step is included: press the dried complex electrode into a certain thickness.

In another particular embodiment of the invention, before dip coating the porous ionic conductive polymer binder solution, the following procedure is included: the current collector holding the electrode materials is calcined under inert gas or N₂ atmosphere to obtain the current collector plus the electrode materials coated with the carbonized substance.

In another particular embodiment of the invention, the abovementioned electrode material is a lithium ion compound, selected from at least one of the following: Li₃V₂(PO4)₃, LiFeMPO₄, LiMnO₂ and LiFePO₄, wherein M represents Ni, Co, Mn, Mg, Ca, Cr, V, Sr in LiFeMPO₄.

In another particular embodiment of the invention, the abovementioned electrode material is selected from at least one of the following: C, Si, SiO₂, N containing compound, SnO₂, Sb₂O₃ and Li₄Ti₅O₁₂.

In the abovementioned electrode fabrication method, the current collector connects with the electrode active material through its porous three-dimensional network and thus improves active material utilization and high area density; in addition, since the current collector is dip coated with a porous ionic conductive polymer binder layer, closer stack with other electrodes and lower cell impedance is achieved; meanwhile the porous ionic conductive polymer binder is able to prevent the electrode material peeling off from the current collector.

### DETAILED DESCRIPTION OF THE PREFERRED EMBODIMENT(S)

The present invention is illustrated by way of example and not by way of limitation. It should be noted that references to ‘an’ or ‘one’ embodiment in this disclosure are not necessarily to the same embodiment, and such references mean at least one. In the following description, various aspects of the present invention will be described. However, it will be apparent to those skilled in the art that the present invention maybe practiced with only some or all aspects of the present invention. However, it will be apparent to one skilled in the art that the present invention may be practiced without the specific details. In other instances, well-known features are omitted or simplified in order not to obscure the present invention.

The complex electrode of the present invention includes the current collector and the electrode material.

The current collector is porous electro-conductive three-dimentional network metal foam with the porosity ranging from 20%-95%. The metal foam is generally selected from Al, Cu, Ni, Ag, Au or their alloy or stainless steel materials.

The electrode active material is filled into the pores and onto the both sides of the abovementioned current collector and thus they connect with each other to form stereo network construction. In addition, the current collector is coated with a porous ionic conductive polymer binder such that closer stack with other electrodes and lower cell impedance is achieved; Furthermore, the porous ionic conductive polymer binder can prevent the electrode material peeling off from the current collector.

Still furthermore, the carbonized substance material is coated between the electrode material and the current collector through calcination to guarantee closer contact of the electrode with the current collector.

Based on the above design conception, the complex electrode for lithium ion battery is fabricated. In the case of a complex cathode, the active material is a lithium ion compound, selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄. In the case of a complex anode, the active material is selected from at least one of the following: C, Si, SiO₂, N containing compound, SnO₂, Sb₂O₃ and Li₄Ti₅O₁₂. In particular, C not only includes graphite (artificial or natural), but also includes graphitized carbon fiber, mesocarbon microbeads (MCMB), hard carbon and carbon nanotube.

In the embodiment of the invention, the complex electrode is generally processed to a plate-like form with a certain even thickness ranging from 100 μm to 100 cm for the convenience of the battery design and assembling. A layer of porous ionic conductive polymer binder solution is dip coated on both the surface of the plate-like form of the electrode and the current collector after pressing the complex electrode. Such construction has the advantages of closer pack of electrode, lower cell impedance and prevention of electrode material loss from the current collector.

The porous ionic conductive polymer binder is selected from at least one of the following: PVDF, PTFE, PEO, PMA, or acrylate based gel polymer. The viscosity of the polymer ranges from 0.1 Pa·s˜10 Pa·s. The thickness of the polymer binder dip coated on the current collector is ranging from 0.1 μm to 10 μm.

The electrode fabrication method disclosed in the present invention includes the following steps: mix the organic binder with the electrode active material and the conductive additive to form electrode slurry; fill the electrode slurry into the pores and onto the both sides of the current collector; remove the solvent in the slurry to dry the electrode; dip coat a layer of porous ionic conductive polymer binder solution on the current collector and the electrode material and dry it to form a complex electrode comprising the electrode active material, the current collector and the polymer binder.

By applying the abovementioned fabrication method, an essential form of electrode for a lithium ion battery is obtained.

In order to obtain a better application result, the abovementioned electrode making process includes additional steps: press the dried complex electrode with the rolling press machine to a targeted thickness; before dip coating the ionic conductive polymer binder solution on the current collector and the electrode, the current collector and the electrode are calcined in the inert or N₂ atmosphere to obtain a thin layer of carbonized substance coated on the electrode material and the current collector.

Aforementioned, the current collector is porous electro-conductive three-dimentional network metal foam with the porosity ranging from 20%-95%. The metal foam is generally selected from Al, Cu, Ni, Ag, Au or their alloy or stainless steel materials.

The drying temperature for the electrode slurry coated on the current collector ranges from 100° C. to 120° C., and the drying time is between 1 and 12 hours. The organic binder is applicable in the non-aqueous electrolyte and it is selected from one of the following: polyethylene (PE), polypropylene (PP), polybutylene (PB), carboxymethylcellulose (CMC), PVDF, PTFE, PAN, EPDM rubber, styrene butadiene rubber (SBR) or polyurethane (PU). The electro-conductive additive in the electrode formulation is selected from carbon black, acetylene black, carbon nanotube, conductive carbon or vapor grown carbon fiber (VGCF). NMP is generally used as the solvent in the electrode slurry.

In the embodiment of the present invention, the current collector coated with the electrode material is pressed into a plate-like form with the rolling press machine. The targeted thickness after pressing is ranging from 100 μm to 100 cm for the convenience of the battery post fabrication process.

In the embodiment of the invention, the calcination process for the current collector and the electrode material is operated in the inert and N₂ atmosphere and the calcination temperature ranges from 500° C. to 1200° C. and the time is from 2 to 8 hrs.

In the embodiment of the invention, the porous ionic conductive polymer binder is selected from PVDF, PTFE, PEO, PMA or acrylate based gel polymer. The viscosity of the polymer ranges from 0.1 Pa·s to 10 Pa·s. The coating layer thickness is from 0.1 μm to 10 μm. The drying temperature for the ionic conductive polymer binder solution is between 100° C. and 120° C., and the drying time is 1-10 hrs.

Aforementioned, the electrode fabrication method disclosed in the present invention can be used in making the complex electrode for the lithium ion battery. Different active materials are used for the cathode and the anode.

Hereinbelow, the present invention will be described in detail with reference to the following examples, which should not be construed as limiting the scope of the present invention.

### Example 1

The Cathode Fabrication Method

Step 1. The cathode slurry is prepared by the following process: 7 g PVDF binder is added into 180 g NMP solvent and mix them thoroughly to form the glue like solution; 140 g LiFePO₄ and 2.8 g Super-P conductive carbon is thoroughly mixed into the above glue like solution, mix them thoroughly in the mixer to form a paste like cathode slurry.

Step 2. Use the foamed aluminum with the porosity of 90% as the current collector. Use a doctor blade to coat the cathode slurry onto the both sides of the foamed Al current collector.

Step 3. Put the electrode slurry coated current collector into 110° C. vacuum oven for 4 hrs to remove NMP solvent and dry it.

Step 4. Press the above dried current collector with a rolling press machine to make the active material packed tighter. The targeted thickness after pressing is determined by the battery design, generally at 500 μm including the current collector imbedded inside the electrode material.

Step 5. Calcine the pressed electrode in N₂ atmosphere at 700° C. for 2 hrs, thereafter to cool it to room temperature, withdraw the electrode from the oven to obtain the electrode with a thin layer of carbonized substance coated on the electrode and the current collector.

Step 6. Dip coat a thin layer of porous ionic conductive polymer binder solution (η=1 Pa·s) onto the current collector holding the electrode active material and the carbonized substance and then put it into the 100° C. vacuum oven to keep 2 hrs to remove solvent and finally to obtain the complex cathode comprising LiFePO₄, the carbonized substance, the current collector and the porous ionic conductive polymer binder.

The complex cathode made according to the above procedure has an area capacity of about 40 mAh/cm², which is much higher than a conventional value around 12 mAh/cm².

### Example 2

The Cathode Fabrication Method

The fabrication steps are generally the same as that of Example 1 and the only difference is existed in the following:

In step 1, the cathode slurry is prepared by the following process: 7 g PVDF binder is added into 180 g NMP solvent and mix them thoroughly to form a glue like PVDF solution. A total of 180 g of Li₂CO₃ and FePO₄ with the molar ratio of Li₂CO₃:FePO₄=1:2 and 2.8 g Super-P conductive carbon was ball milled for 4 hrs using IPA as the dispersion media. After ball milling, dry and grind the mixture and add them into the PVDF solution, thoroughly mixed them to form a paste like cathode slurry.

In step 5, the pressed current collector holding Li₂CO₃ and FePO₄ is calcined in N₂ atmosphere at 750° C. for 3 hrs, cool it to room temperature, and withdraw it from the oven to obtain the complex cathode comprising LiFePO₄ cathode, the current collector, the carbonized substance and the porous ionic conductive polymer binder.

### Example 3

The Cathode Fabrication Method

The fabrication steps are generally the same as that of Example 1 and the only difference is existed in the following:

In step 1, the cathode slurry is prepared by the following process: 7 g PVDF binder is added into 180 g NMP solvent, and mix them thoroughly to form a glue like PVDF solution. A total of 180 g of Li₂CO₃, MnO₂ and glucose with the molar ratio of Li:Mn:C=1:2:1 and 2.5 g Super-P conductive carbon were ball milled for 4 hrs using IPA as the dispersion media. After ball milling, dry and grind the mixture and add them into the PVDF solution, thoroughly mixed to form a paste like cathode slurry.

In step 5, the pressed current collector holding Li₂CO₃, MnO₂ and glucose is calcined in N₂ atmosphere at 350° C. for 2 hrs and then 750° C. for 2 hrs, cool to room temperature, withdraw it from the oven to obtain the complex electrode comprising LiMnO₂ cathode, current collector, the carbonized substance and the porous ionic conductive polymer binder.

Hereinbelow, the fabrication of the complex anode is described in the following examples:

### Example 4

The Anode Fabrication Method

Step 1. The anode slurry is prepared by the following process: 7 g PVDF binder is added into 180 g NMP solvent, and mix them thoroughly to form a glue like PVDF solution; 70 g Li₄Ti₅O₁₂ and 1.4 g Super-P conductive carbon is thoroughly mixed into the above PVDF solution, mix them thoroughly in the mixer to form a paste like anode slurry.

Step 2. Use the foamed copper with the porosity of 90% as the current collector. Use a doctor blade to coat the anode slurry onto the both sides of the foamed Cu current collector.

Step 3. Put the anode slurry coated current collector into 110° C. vacuum oven for 4 hrs to remove NMP solvent and dry it.

Step 4. Press the above dried current collector with a rolling press machine to make the active material packed tighter. The targeted thickness after pressing is determined by the battery design, generally at 200 μm including the current collector imbedded inside the electrode material.

Step 5. Calcine the pressed electrode in N₂ atmosphere at 650° C. for 3 hrs, thereafter to cool it to room temperature, withdraw the electrode from the oven to obtain the electrode with a thin layer of carbonized substance coated on the electrode and the current collector.

Step 6. Dip coat a thin layer of porous ionic conductive polymer binder solution (η=1 Pa·s) onto the current collector having the electrode active material and the carbonized substance and then put it into the 100° C. vacuum oven to keep 2 hrs to remove solvent and finally to obtain the complex anode comprising Li₄Ti₅O₁₂, the carbonized substance, the current collector and the porous ionic conductive polymer binder.

The complex anode made according to the above procedure has an area capacity of about 44 mAh/cm², which is much higher than a conventional value around 13.2 mAh/cm².

### Example 5

The Anode Fabrication Method

The fabrication steps are generally the same as that of Example 4 and the only difference is existed in the following:

In step 1, the anode slurry is prepared by the following process: 7 g PVDF binder is added into 180 g NMP solvent and mix thoroughly to form glue like PVDF solution. 60 g of nano silica, 10 g of carbon nanotube and 1.4 g Super-P conductive carbon were added into the PVDF solution, thoroughly mixed to form a paste like anode slurry.

### Example 6

The Anode Fabrication Method

The fabrication steps are generally the same as that of Example 4 and the only difference is existed in the following:

In step 1, the anode slurry is prepared by the following process: 7 g PVDF binder is added into 180 g NMP solvent, and mix them thoroughly to form glue like PVDF solution. A total of 110 g of Li₂CO₃ and TiO₂ with the molar ratio of Li:Ti=4:5 and 1.8 g Super-P conductive carbon were added together and ball milled for 4 hrs using alcohol as the dispersion media. After ball milling, dry and grind the mixture and add them into the PVDF solution, thoroughly mixed to form a paste like anode slurry.

In Step 5, the pressed current collector having Li₂CO₃ and TiO₂ is calcined in N₂ atmosphere at 700° C. for 4 hrs and then cool it to room temperature, withdraw it from the oven to obtain the complex anode comprising Li₄Ti₅O₁₂ anode, the current collector, the carbonized substance and the porous ionic conductive polymer binder.

The present invention disclosed is useful for fabrication of both cathode and anode with a simplified electrode construction and processing procedure. In summary, it has the following advantages:

In the embodiment of the invention, the current collector connects with the electrode materials through its porous three-dimensional network construction. Compared with the conventional solid metal foil form of current collector, the porous network current collector in the present invention is effective to improve the active materials utilization and the higher electrode area density. Furthermore, after the calcination process, the distance among the carbonized substance, the electrode material and the current collector is only within the magnitude of nanometers and thus they have close contact with each other. This can effectively relieve the mechanical stress generated from the charge-discharge process and thus to improve the connection stability of the electrode and the current collector and also the cycling stability of the battery cell.

The pressing step in the electrode fabrication process disclosed in the present invention can be utilized to make a plate-like form of complex electrode with a varied thickness. Therefore the electrode fabricated through this process can satisfy both higher capacity and good mechanical property, especially the anti-bending capability of the electrode. Further, this process can also be used to make a thicker electrode where higher energy density of the battery is demanded.

In addition, in contrast to the conventional electrode fabrication technique where the electrode directly coated on the solid metal foil, the porous current collector of the present invention connects with the electrode active material through its three-dimensional network construction and this greatly narrows down the distance of electron transporting to the nanometer level. This novel processing method provides more stable interfaces among the different materials and thus effectively relives the stress for the electrode peel-off from the current collector and guarantees the reduction of the cell impedance during prolonged cycling process. Consequently, the comprehensive electrochemical performance of the battery cell can be improved and the production cost is also reduced.

The porous polymer binder in the current collector and the electrode active material not only affords the non-interface contact among the different electrodes, but also lowers down the whole battery impedance; moreover, it can also prevent the electrode active material loss from the current collector.

The above disclosed embodiments are only the concrete description of the several specific examples of the present invention. They are provided for illustrative purpose of the design concept of the present invention and they should not be construed as limited to the embodiments set forth herein. It is worthwhile to be noted that, apparently for those skilled in the art, some alterations or improvements may also be possible based on the design concept of the present disclosure. Any alterations or improvement within the framework of the present inventive design concept is also under the protection right of the disclosure.

What is claimed is:

1. A complex electrode for lithium ion battery, consisting of:
an electro-conductive current collector, with a porous three-dimensional network construction;
the electrode active materials, filled in the pores of the above mentioned current collector; and
a porous ionic conductive polymer binder layer, coated in the pores of the abovementioned current collector and the electrode active materials.

2. The complex electrode of claim 1, wherein the electrode active material is a lithium ion compound, selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄.

3. The complex electrode of claim 1, wherein the electrode material is selected from at least one of the following: C, Si, SiO₂, N containing compound, SnO₂, Sb₂O₃ and Li₄Ti₅O₁₂.

4. The complex electrode of claim 1, wherein the current collector is porous metal foam with the porosity of 20%-95%.

5. The complex electrode of claim 1, wherein the electrode material is coated with the carbonized substance through calcination.

6. The complex electrode of claim 1, wherein the porous ionic conductive polymer binder is selected from at least one of the following: polyvinylidene fluoride (PVDF), poly tetrafluoro ethylene (PTFE), polyethylene oxide (PEO), poly (methyl acrylate) (PMA), or acrylate based gel polymer.

7. A fabrication method for lithium ion battery electrode, wherein the process consists of the following steps:
use a solvent to mix the organic binder, electrode active materials and the conductive additives together to form the electrode slurry;
provide a porous electro-conductive current collector with three-dimensional network construction;
fill the electrode slurry in the pores of the above-mentioned current collector;
dry the above-mentioned current collector holding the electrode slurry to remove the solvent;
dip coat a porous ionic conductive polymer binder solution onto the abovementioned current collector and the electrode material, remove the solvent in a dry environment to form the complex electrode comprising the abovementioned electrode materials, the current collector and the porous ionic conductive polymer binder.

8. The electrode fabrication method of claim 7, wherein the following step is also included:
press the dried complex electrode into a certain thickness.

9. The electrode fabrication method of claim 8, wherein the following step is also included before the porous electro-conductive polymer binder solution is dip coated on the current collector: the current collector holding the electrode active materials is calcined under inert gas or N₂ atmosphere to obtain a carbonized substance coated on the electrode material.

10. The electrode fabrication method of any one of the claim 7, wherein the electrode material is a lithium ion compound, the lithium ion compound is selected from at least one of the following: Li₃V₂(PO₄)₃, LiFeMPO₄, LiMnO₂ and LiFePO₄, wherein M represents Ni, Co, Mn, Mg, Ca, Cr, V, Sr in LiFeMPO₄.

11. The electrode fabrication method of any one of the claim 7, wherein the electrode material is selected from at least one of the following: C, Si, SiO₂, N containing compound, SnO₂, Sb₂O₃ and Li₄Ti₅O₁₂.
